(19) United States
(12) Patent Application Publication
(10) Pub. No.: US 2017/0138513 A1
(43) Pub. Date: May 18, 2017

(54) Safety Hose with Metal Mesh Protection Layer

(71) Applicants: Lars Petter Andresen, Oslo (NO); Michael J. Batt, West Windsor, NJ (US)

(72) Inventors: Lars Petter Andresen, Oslo (NO); Michael J. Batt, West Windsor, NJ (US)

(21) Appl. No.: 15/175,257

(22) Filed: Jun. 7, 2016

Related U.S. Application Data
(63) Continuation-in-part of application No. PCT/US15/14944, filed on Feb. 8, 2015.
(60) Provisional application No. 61/913,265, filed on Dec. 7, 2013.

(51) Int. Cl. F16L 11/08; D04C 1/06; F16L 11/02

(52) U.S. Cl. CPC F16L 11/086; F16L 11/02; D04C 1/06

(57) ABSTRACT

Safety hoses protected by wire mesh and an apparatus for manufacturing them are disclosed. The hose assembly has an inner flexible tube, wrapped with two helices made of ribbons of woven, wire mesh. An outer flexible tube is fitted over the helixes. The ribbon is woven from metal fibers having a diameter of less than 0.20 mm and open apertures of less than 0.45 mm. The ribbon is preferably made of bias-cut material and the pitch of the helixes is such that the warp threads of the ribbons overlap at an angle between 15 and 33 degrees. Alternately the hose may be ribbon braided, having two or more ribbons of woven wire mesh braided together over the inner tube. A modified “May pole” braiding machine to accomplish such ribbon braiding is disclosed.

### CLAIM OF PRIORITY

This application is a US utility non-provisional application that is a continuation-in-part of PCT/US15/14944 filed on Monday Feb. 8, 2015, which in turn claims priority to U.S. provisional patent application 61/913,265 filed on Dec. 7, 2013, the contents of all of which are hereby incorporated by reference in their entirety.

PCT/US15/14944 was filed along with a Request to Restore Priority. As Feb. 8, 2015 was a Monday, this was timely filed within 2 months from the Dec. 7, 2014 expiration date of U.S. provisional application 61/913,265.

This application is also related to, and claims priority for material added to the PCT application, from U.S. patent application Ser. No. 14/992,829 filed on Jan. 11, 2016, the contents of which are hereby incorporated by reference in their entity.

### FIELD OF THE INVENTION

The invention relates to pipes and tubular conduits having structure for protecting a pipe from kinking, being bent too abruptly, or from wear due to its coming in contact with other objects, and more particularly to safety hoses having woven metal mesh, and woven metal mesh/paramid fiber combination materials, as a protective layer to prevent puncture, cut or abrasion damage to the pipe.

### BACKGROUND OF THE INVENTION

Flexible hose assemblies are utilized generally to transfer fluids between spaced fluid pressure lines or the like at various conditions of temperature and pressure, particularly where there is relative movement between the lines. Such flexible hose assemblies used to establish fluid communication are often in close proximity to components that may have sharp edges or needle like protrusions, so that in addition to needing to withstand a great number of flexing cycles, the hoses are required to resist abrasion, cutting and puncturing.

Many devices are employed for protection and routing control of hose assemblies. There is however, a continued need for improved hose assemblies that combine high flexibility with high protection against abrasion, cutting and puncturing.

### DESCRIPTION OF THE RELATED ART

The relevant prior art wiring includes:

U.S. Pat. No. 4,345,624 issued to Rider on Aug. 24, 1982 entitled “Blow-out guard for high-pressure hoses” that describes a blow-out guard for use with high-pressure conduits. A double layer, wire sheath is fixedly attached over the end portion of the hose. If the hose should burst the medium escapes through the interstices of the sheath and is thereby reduced to a dispersed effluent, or a fine spray, thus protecting the operator.

U.S. Pat. No. 3,707,032 issued to Brunelle et al. on Dec. 26, 1972 entitled “Method of forming an Abrasion Resistant Hose Assembly” that describes an abrasion resistant flexible hose assembly includes a length of flexible hose having hose end fittings attached to its ends and abrasion resistant means in the form of separate annular bumpers arranged along the hose in longitudinally spaced positions. Each bumper encircles a small portion of the length of the hose and cooperates with the other bumpers to protect the hose from abrading engagement with adjacent structures. The bumpers individually engage the hose with a shrink fit to maintain their spacing.

U.S. Pat. No. 4,602,808 issued to Herron et al. on Jul. 29, 1986 entitled “Protective routing sleeve for hose assembly” that describes a flexible corrosion-resistant tubular sleeve that provides protection for hose assemblies subjected to abrasion, kinking, or accidental rupture due to flexure. The sleeve also provides routing control for hose end assemblies, providing greater axial strength, yet greater flexibility by the incorporation of a helical body portion. In a preferred embodiment, the sleeve is a single-piece body of molded polypropylene, and defines a pair of annular end portions integrally joined together by the helical body portion.

U.S. Pat. No. 3,578,026 issued to Meyer, Jr. on May 11, 1971 entitled “Jacket for Flexible Hose” that describes a hose jacket made of acetal resin and designed to bend a flexible hose approximately 90 degrees that is formed in two partial semi-toroidal sections joined together at the outer radius by a flexible hinge portion of the resin. The sections have an annular cavity conforming approximately to the size and shape of the hose. Folding the sections around the hose and latching the arcuate edges together at each end and the middle bends the hose sharply without kinking or damaging the hose walls. Forces exerted on the jacket by the hose assist in maintaining the latch elements in engagement with each other.

Various implements are known in the art, but fail to address all of the problems solved by the invention described herein. Various embodiments of this invention are illustrated in the accompanying drawings and will be described in more detail herein below.

### SUMMARY OF THE INVENTION

An inventive system of safety hoses protected by wire mesh and methods and apparatus for manufacturing them is disclosed.

In a preferred embodiment, the hose assembly may include an inner, extruded, smooth bore, flexible tube around which a ribbon of wire mesh may be wrapped in a helical fashion in, for instance, a clockwise helical direction. In a preferred embodiment, the edges of the helix may overlap slightly in order to provide more protection, although in alternate embodiments, the helix may not overlap each other in, for instance, a tradeoff between the level of puncture and cut resistance and the economy of using less material or providing more flexibility.

A second ribbon of wire mesh may then be wrapped around the first, but in a counter-clockwise direction.

An outer, extruded flexible tube may then be fitted over said first and second helixes. In a preferred embodiment, the ribbons are only held in place by the tubing and are free to slide over each other so as to help provide good flexibility of the entire tube. In alternate embodiments, the ribbons may be attached to themselves, each other, or both by spot attachments such as, but not limited to, spot gluing, spot soldering, spot welding or some combination thereof. This may, for instance, help maintain the helical structure particularly in longer lengths of tubing.

In a preferred embodiment, the metal mesh ribbon may be woven from metal fibers such as, but not limited to, stainless steel wires, having a diameter of less than 0.20 mm with apertures between the wires being less than 0.45 mm. These dimensions have been found to provide both good puncture and cut resistance. The ribbon is preferably in a range of 1 to 3 cm, though the ribbon may be wider or smaller, depending on the diameter of the tube assembly.

In a preferred embodiment, the ribbon may be bias-cut material in order to provide good flexibility along the length of the helix, though alternate embodiments may use conventionally cut ribbon in order, for instance, to save on cost or material.

In a preferred embodiment the pitch of the helix may be adjusted so that the warp threads of the two ribbons overlap at an angle between 15 and 33 degrees, and more preferably, at an angle of 21.5 degrees as this has been shown to, on average, provide the best resistance to puncture.

In a further preferred embodiment, the safety hose may be ribbon braided hose assembly that may include an inner, extruded smooth bore, flexible tube around which two or more ribbons of woven wire mesh may be braided together.

Such braiding of ribbon may, for instance, be accomplished using a modified version of a simple two ribbon carrier designed to perform “May pole”. One of the modifications may be to provide an articulated ribbon carrier as described in detail below.

Therefore, the present invention succeeds in conferring the following, and others not mentioned, desirable and useful benefits and objectives.

It is an object of the present invention to provide flexible hose having greater cut and puncture resistance than currently available hose.

It is another object of the present invention to provide protected flexible hose having smaller bending radius than currently available hose.

Yet another object of the present invention is to provide more cost effective flexible hose.

### BRIEF DESCRIPTION OF THE DRAWINGS

FIG. 1 shows an isometric, partially cut away, drawing of a helically wrapped hose assembly of a preferred embodiment of the present invention.

FIG. 2 A shows a plan view of a conventionally cut ribbon of metal mesh.

FIG. 2 B shows a plan view of a bias cut ribbon of metal mesh.

FIG. 3 shows a section of helical, metallic layer of a preferred embodiment of the present invention.

FIG. 4 A shows a pair of conventionally cut ribbons of metal mesh overlapped in accordance with a preferred embodiment of the present invention.

FIG. 4 B shows a pair of bias cut ribbons of metal mesh overlapped in accordance with a preferred embodiment of the present invention.

FIG. 5 shows an isometric, partially cut away, drawing of a ribbon braided hose assembly of a preferred embodiment of the present invention.

FIG. 6 shows a schematic, isometric, drawing of a ribbon braiding machine of a preferred embodiment of the present invention.

FIG. 7 shows a schematic, side view of a ribbon braiding machine of a preferred embodiment of the present invention.

FIG. 8 shows a schematic, plan view of a ribbon braiding machine of a preferred embodiment of the present invention.

FIG. 9 shows an isometric view of a protective, composite fabric of a further preferred embodiment of the present invention.

FIG. 10 shows an isometric view of an inter-woven para-aramid/metal fiber fabric of a further preferred embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

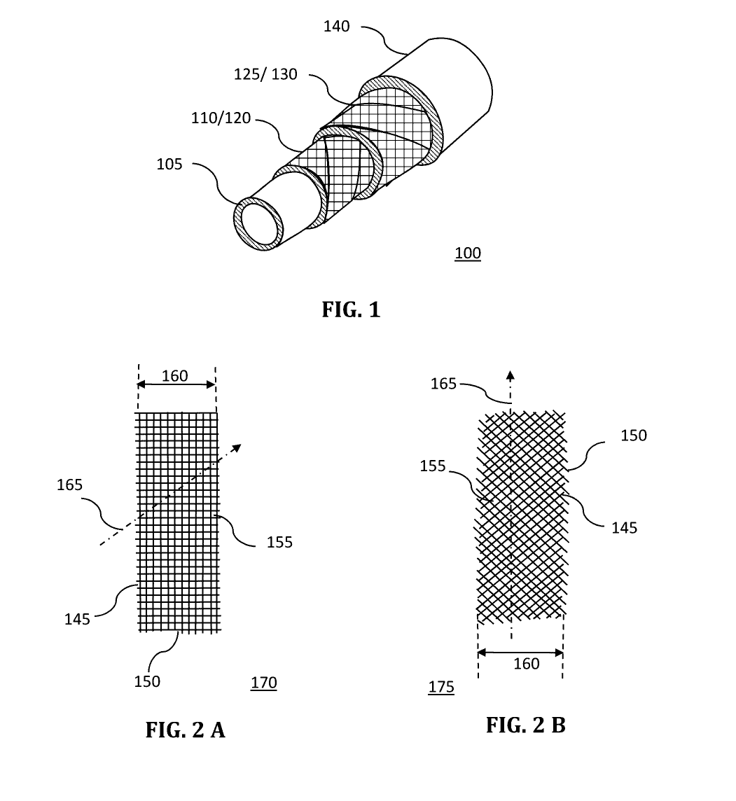

FIG. 1 shows an isometric, partially cut-away, drawing of a helically wrapped hose assembly of a preferred embodiment of the present invention.

The helically wrapped hose assembly 100 may, for instance, include a inner, extruded smooth bore, flexible tube 105, an first helical, metallic layer 110 made of a clockwise, overlapped helix 120, a second helical, metallic layer 125 made of a counter-clockwise overlapped helix 130, and an outer, extruded flexible tube 140.

The inner, extruded smooth bore, flexible tube 105 may be made of a material suitable for conveying the fluid that the helically wrapped hose assembly 100 is designed to carry. For instance, a fluoroelastomer inner tube, or an inner tube with a fluoroelastomer coating, may have wide chemical performance and be capable of handling high temperatures. Fluoroelastomers may, for instance, include the family of materials such as, but not limited to, copolymers of hexafluoropropylene (HFP) and vinylidene fluoride (VDF or VF2), terpolymers of tetrafluoroethylene (TFE), vinylidene fluoride (VDF) and hexafluoropropylene (HFP) as well as perfluoromethylvinylether (PMVE).

FIG. 2 A shows a plan view of a conventionally cut ribbon of metal mesh. In a ribbon cut conventionally 170 the bias direction 165 may be at 45 degrees to either the warp thread 145 or the weft thread 150 of metal mesh.

In a preferred embodiment, the ribbons used in the helically wrapped hose assembly 100 are made of a metal mesh in which the wires having a diameter of less than 0.20 mm and the apertures between the wires 155 are less than 0.45 mm.

In a more preferred embodiment, the woven metallic threads may have a diameter that is less than 170 μm in diameter, and may be woven to have an open area of less than 55%. The materials may preferably be made of a chromium steel such as, but not limited to, Grade 316 L stainless steel, as this may provide the best combination of strength, durability and corrosion resistance. In alternative embodiments the, wire used may be a metal or metal ally such as, but not limited to, stainless steel, steel, aluminum, iron, copper, bronze, brass, magnesium, magnelium, titanium, zinc or some combination thereof. The metal may be chosen to optimize some quality such as, but not limited to, cost, wear, durability, weight or wearability or some combination thereof. The woven material may, for instance, have a combination of such metals used by, for instance, using a different thread for the warp and the weft threads, or by alternating use of types of threads in either the warp or weft threads or some combination thereof. The may be done to optimize some quality such as, but not limited to, cost, wear, durability, weight or wearability or some combination thereof.

FIG. 2 B shows a plan view of a bias cut ribbon of metal mesh. The ribbon may be cut so that the bias direction 165 of the woven metal mesh may be oriented substantially parallel to the length of the ribbon, and therefore, at substantially 45 degrees to both the warp threads 145 and the weft threads 150.

Laboratory testing has shown that cutting the insert so that the bias aligns with the length of the ribbon and, therefore, orthogonal to the axis of bending, enables the useable lifetime of articles made of the mesh to be extended by a factor of 3-4 times, i.e., it quadruples the lifetime, without impacting the cut or puncture characteristics of the material. (SINTEF® Report on Tensile and Fatigue Tests, Sep. 23, 2013 is attached as Appendix A and hereby incorporated by reference in its entirety. The increase in lifetime, and especially the magnitude of the increase, was a surprising and unexpected result.

The width 160 of the ribbon may depend on the diameter of the tubing and may typically be in a range of 1 to 3 cm.

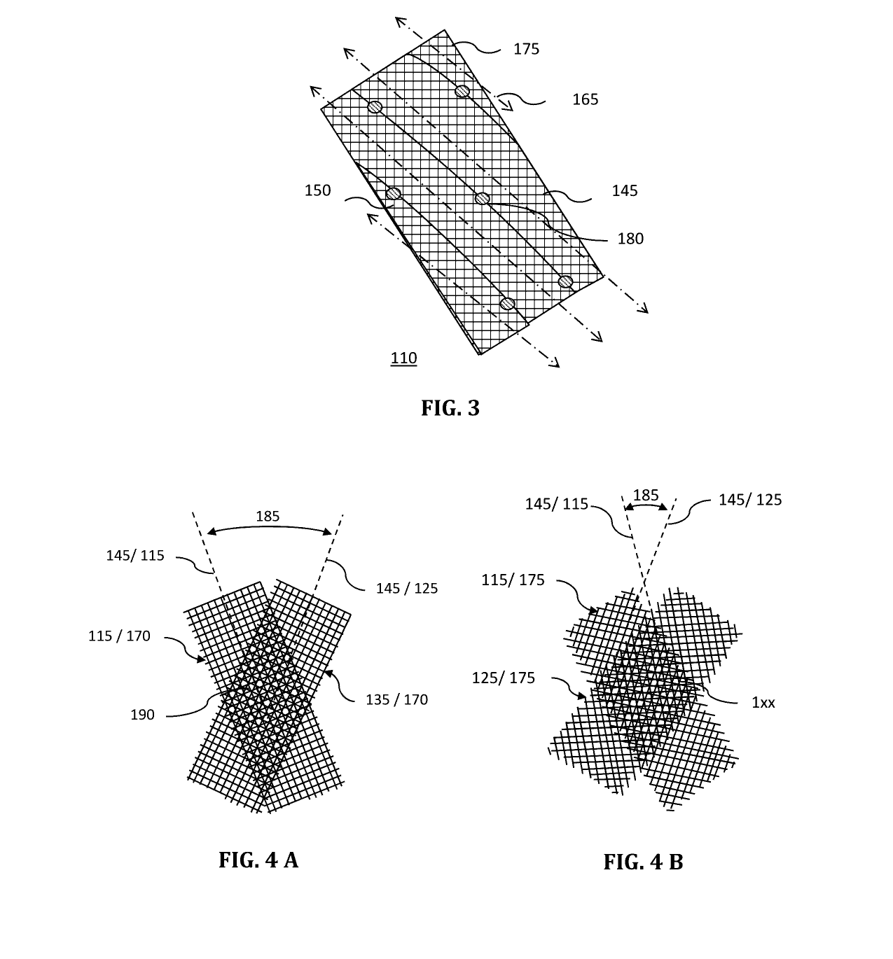

FIG. 3 shows a section of helical, metallic layer of a preferred embodiment of the present invention.

The helical, metallic layer 110 may be made up of a continuous length of bias cut ribbon 175, i.e., a ribbon cut such that the bias direction 165, which may be at 45 degrees to both the warp thread 145 and the weft thread 150, is oriented substantially along the length of the ribbon.

In a preferred embodiment, the ribbon may be wound so that it overlaps to an extent of each turn of the helix as this may provide the best protection against both puncture and cut.

In alternate embodiments, the ribbon may not overlap in order to accommodate a tradeoff between, for instance, degree of protection and cost of materials, flexibility of the tubing or some combination thereof.

The helical layer may be free floating to allow for good flexibility, or it may have one or more spot glue locations 180 that may adhere it to an adjacent turn of the helix, to the underlying or overlaying tube or to another helix, or some combination thereof. The spot glue locations 180 may consist of spots of glue, or may be where the materials may be permanently joined by methods such as, but not limited to, soldering, welding, ultrasonic heating, or some combination thereof.

FIG. 4 A shows a pair of conventionally cut ribbons of metal mesh overlapped in accordance with a preferred embodiment of the present invention.

A first ribbon of wire mesh 115 that may be cut conventionally 170 may overlap a second ribbon of wire mesh 135 that may also be conventionally cut ribbon 170. The pitch of the helixes may be adjusted such that the warp thread 145 of the first ribbon of wire mesh 115 is oriented at an angle 185 to the warp thread 145 of the second helical, metallic layer 125.

In a preferred embodiment, the angle 185 may be in range of 15 to 33 degrees as this has been shown to provide good average resistance against puncture. In a more preferred embodiment, the angle 185 may be 21.5 degrees as this has been found, on average, to provide the best resistance against puncture.

FIG. 4 B shows a pair of bias cut ribbons of metal mesh overlapped in accordance with a preferred embodiment of the present invention.

A first ribbon of wire mesh 115 that may be bias cut 175 may overlap a second ribbon of wire mesh 135 that may also be bias cut ribbon 175. The pitch of the helixes may be adjusted such that the warp thread 145 of the first ribbon of wire mesh 115 is oriented at an angle 185 to the warp thread 145 of the second helical, metallic layer 125.

In a preferred embodiment, the angle 185 may be in range of 15 to 33 degrees as this has been shown to provide good average resistance against puncture. In a more preferred embodiment, the angle 185 may be 21.5 degrees as this has been found, on average, to provide the best resistance against puncture.

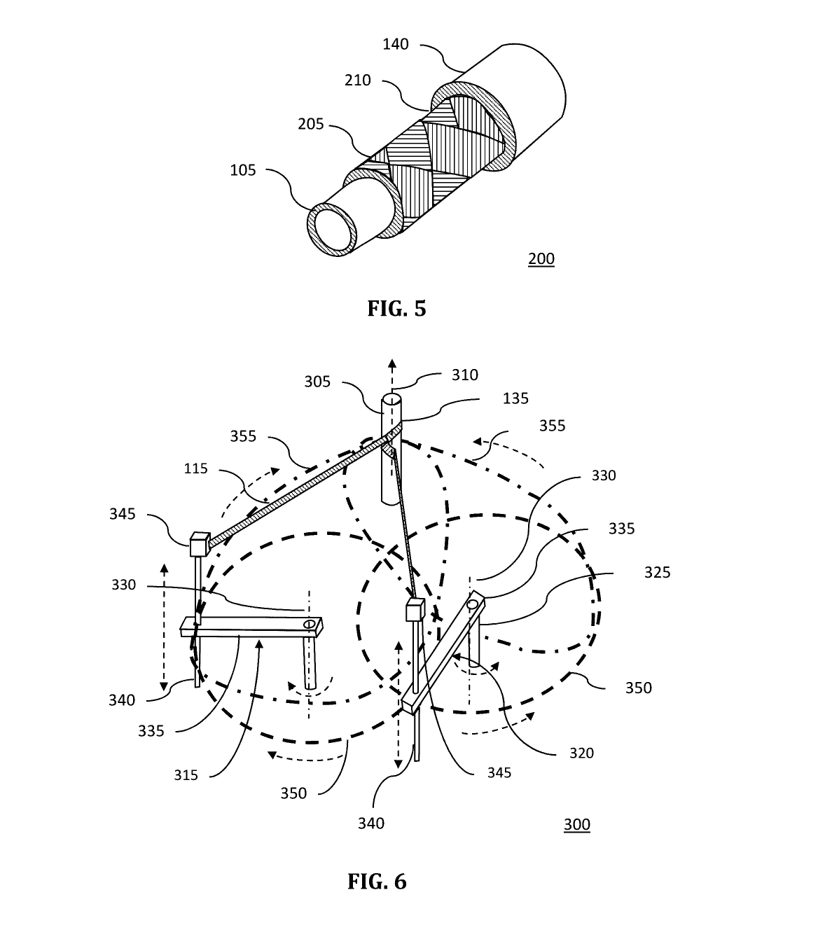

FIG. 5 shows an isometric, partially cut away, drawing of a ribbon braided hose assembly of a preferred embodiment of the present invention.

The ribbon braided hose assembly 200 may include an inner, extruded smooth bore, flexible tube 105, around which a first braided ribbon 205 is interlaced with a second braided ribbon 210 in alternating helixes. The ribbon braided hose assembly 200 may also include an outer, extruded flexible tube 140.

The inner, extruded smooth bore, flexible tube 105, outer, extruded flexible tube 140 and the braided, wove wire mesh ribbons may be of the types, compositions and sizes, or combinations thereof, as, for instance, the corresponding elements and materials described in detail above.

FIG. 6 shows a schematic, isometric, drawing of a ribbon braiding machine of a preferred embodiment of the present invention.

The ribbon braiding machine 300 is a modification of a well-known conventional thread or wire braiding machine, particularly of the type known colloquially as “May pole” braiding machines. In a thread or wire braiding machine, the thread or wire may be kept at approximately the same angle with respect to the mandrel about which the braiding is being done, by a simple ring arrangement close to the mandrel. However, this requires the thread or wire to twist as it travels toward the mandrel. Ribbon cannot undergo such twisting and form a flat braid. In order to braid ribbon, rather than wire or thread, another solution has to be found. The ribbon braiding machine 300 is one such solution to the problem.

The ribbon braiding machine 300 shown in FIG. 6 may include a cylindrical mandrel 305 on which the two ribbons are braided as the cylindrical mandrel 305 moves upward along a mandrel axis of motion 310.

The first ribbon of wire mesh 115 and the second ribbon of wire mesh 135 that are being braided are fed by ribbon carrying bobbins 345 carried on a first ribbon carrying armature 315 and a second ribbon carrying armature 320.

As the first ribbon carrying armature 315 rotates in a clockwise direction around the member axis of rotation 330, with the distal end of the armature arm 335 following the circular path 350, the ribbon carrying bobbin 345 may be moved in a vertical direction while being carried on the carrier shaft 340. The motion of the ribbon carrying bobbin 345 may be the combined motion of the carrier shaft 340 and the armature arm 335, resulting in the ribbon carrying bobbin 345 following the 3-D locus 355.

Similarly, a second ribbon carrying armature 320 may be rotating in an anti-clockwise direction around the member axis of rotation 330 of the rotational member 325. The distal end of the armature arm 335 may follow the circular path 350. At the same time the ribbon carrying bobbin 345 may be moved up or down on the carrier shaft 340 such that it may follow the 3-D locus 355 of the ribbon carrying bobbin 345.

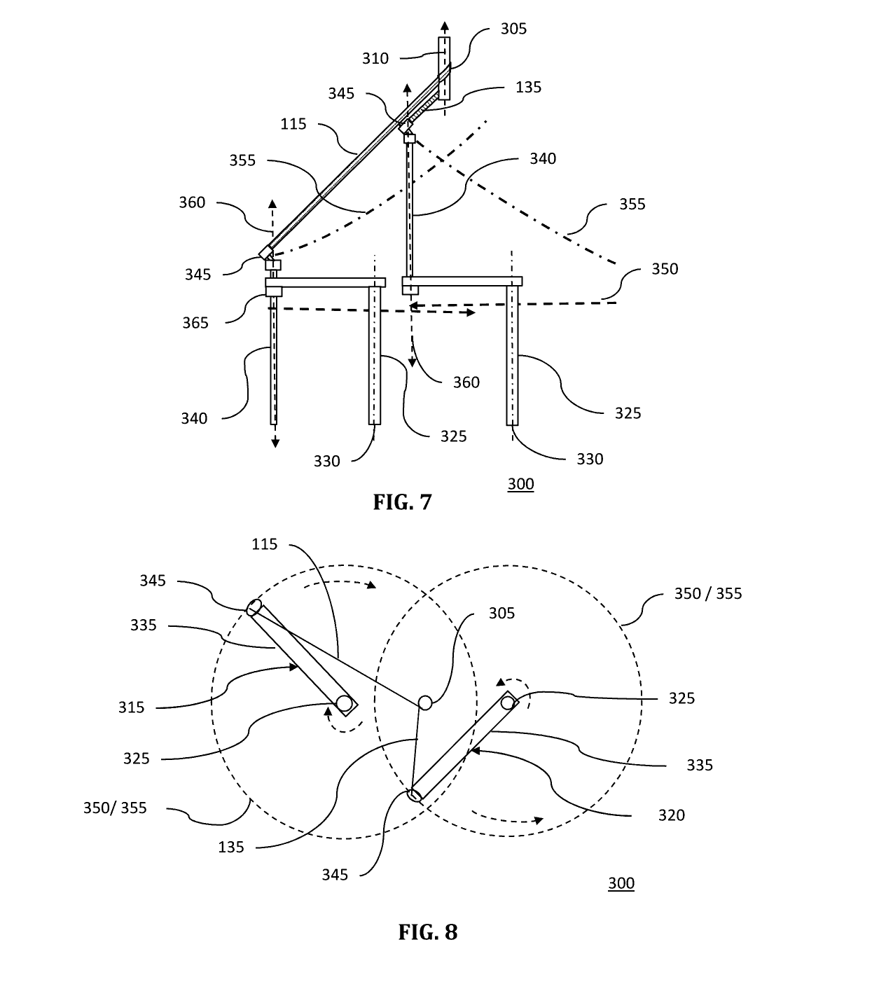

FIG. 7 shows a schematic, side view of a ribbon braiding machine of a preferred embodiment of the present invention.

In FIG. 7, the cylindrical mandrel 305, around which the ribbons are being braided, may move vertically along the mandrel axis of motion 310 so that the ribbons of wire mesh 115 and 135 that are being braided may be wrapped round in a helical manner.

The ribbons may be fed from ribbon carrying bobbins 345 that may be mounted on carrier shafts 340. As the ribbon carrying bobbins 345 rotate around the member axis of rotation 330, following the circular paths 350, the ribbon carrying bobbins 345 may also be moved up and down by the carrier linear actuators 365 so that they follow the 3-D loci 355.

FIG. 8 shows a schematic, plan view of a ribbon braiding machine of a preferred embodiment of the present invention.

The first ribbon carrying armature 315 and the second ribbon carrying armature 320 may rotate in opposite directions. As shown in FIG. 8, the armature arm 335 of the first ribbon carrying armature 315 may rotate in a clockwise direction around its rotational member 325. At the same time, the armature arm 335 of the second ribbon carrying armature 320 may rotate in a counterclockwise direction around its rotational member 325. Although the circular path 350 of the distal end of the armature arm of the first ribbon carrying armature 315 may overlap with the circular path 350 of the distal end of the armature arm of the second ribbon carrying armature 320, the armature arms 335 may be positioned so they do not collide. Similarly, although the cylindrical mandrel 305 on which the ribbons 135 and 115 are braided may lie within both the circular path 350 of the distal end of the armature arms and the 3-D locus 355 of the ribbon carrying bobbins 345, it may be positioned above them so that they do not collide with it.

Both the rotational members 325 and the carrier shafts 340 may be powered by motors such as, but not limited to, well-known AC or DC electric motors, and may be controlled by a controller such as, but not limited to, a programmed digital processor.

In this way a tubular fabric of braided ribbon, including braided ribbons of metal-mesh, may be created. The diameter of the tubular fabric may vary depending on the dimensions of the components of the ribbon braiding machine 300. For typical hose applications the tubular fabric may have a diameter of between 1 cm and 10 cm, but one of ordinary skill in the art will appreciate that larger or smaller diameter tubular fabric may be made using the same inventive concepts of the ribbon braiding machine 300 described above.

The ribbon braided pipe and the machinery to perform the braiding have been described above with reference to ribbon made of metal mesh. The same inventive methods may, however, be applied in further embodiments in which the ribbon may, for instance, be a metal paramid combination.

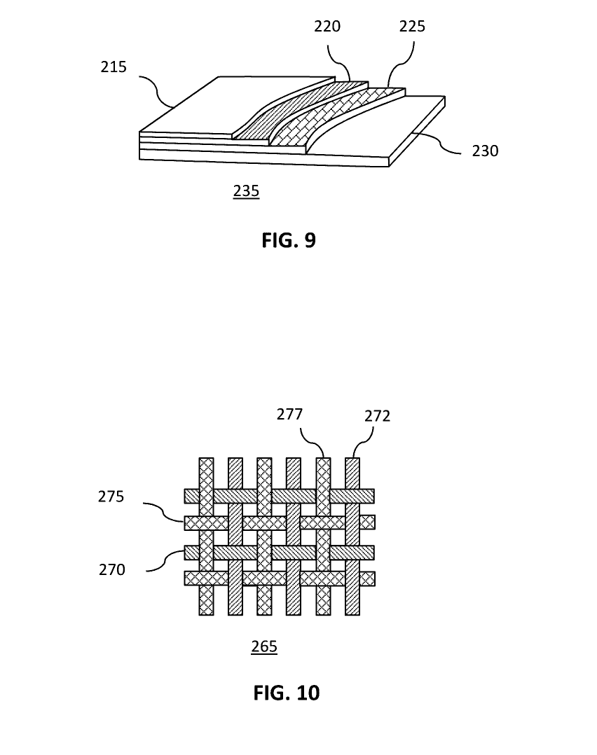

FIG. 9 shows an isometric view of a protective, composite fabric of a further preferred embodiment of the present invention. The protective, composite fabric 235 may, for instance, be made up of an inner protective layer 230, a metal mesh layer 225, a microflex fabric layer 220 and an outer protective layer 215.

The inner and outer protective layers may be any fabric or coating suitable for protection against environmental factors and frictional wear such as, but not limited to, a fabric woven from cotton, a rubber, a polymer or some combination thereof.

In a preferred embodiment, the microflex fabric layer 220 is preferably made of woven para-aramid yarn. Para-aramid yarns are well-known and sold by, for instance, E. I. du Pont de Nemours and Company of Wilmington, Del. under the tradename Kevlar™ and Teijin Aramid of Arnhem, Netherlands under the tradename Twaron™. Woven para-aramid fabrics have become widely used in body-armor because of their high resistance to ballistic penetration. Such fabrics are, however, susceptible to puncture type penetration, particularly cut and slash penetration and to needle stick penetration.

The metal mesh layer 225 is preferably a woven metallic mesh, and more preferably a woven mesh of stainless steel fibers having a diameter of 0.2 mm or less and a mesh aperture of 0.45 mm or less. Such a mesh has been found to have good resistance to cut and slash penetration and to needle stick penetration, and has been used in protective garments such as, but not limited to, protective gloves, as described in, for instance, U.S. Pat. No. 6,581,212 issued to Andresen on Jun. 24, 2003, the contents of which are hereby incorporated by reference in their entirety. However, the number of metal mesh layers 225 of the type described above that may be needed to provide, for instance, adequate puncture penetration may result in wrapped hose assemblies that may not have as much flexibility as desired or may be more costly to produce than desired.

In investigating methods of improving protective garments such as gloves, a trial combination of a fabric combining a microflex fabric layer 220 with a metal mesh layer 225 was found to have an unexpected property. The puncture resistance of the combined layers was found to be 30-40% greater than what would be expected from an additive combination of the puncture resistance of the two individual layers. This surprising and unexpected finding may allow lighter, cheaper and more flexible garments to be constructed from the composite material.

While the exact mechanism for this unexpected improvement in the material properties of the composite material may, as yet, not be fully understood, several factors may be of significance.

It is well-know that the ballistic stopping power of poly-aramid materials is a result of their absorbing the kinetic energy of the impacting missile. A bullet, for instance, on impacting the fabric has its kinetic energy absorbed in breaking the poly-aramid strands as it attempts to penetrate the material. The strands essentially attach themselves to the bullet, absorbing the bullets kinetic energy as they are stretched to their breaking point. To maximize the interaction between the bullet and the material, makers of poly-aramid fabrics attempt to make the fibers of poly-aramid as small as possible thereby increasing the “working surface” of the fibers that interact with the bullet.

The preferred Kevlar™ fabric used for bullet proof vests in, for instance, made from Kevlar 29 yarn. Kevlar 29 yarn is made of approximately 1000 fibers wound together to form a yarn having a denier of approximately 1,500 dtex. (“Denier” is both a standard measurement of filament size and a term used more loosely to merely say “filament size”. The unit “dtex” is an internationally recognized measure of yarn or filament size and is the weight in grams of 10,000 meters of the yarn or filament). A 1000 filament yarn having a denier of 1,500 dtex implies a denier for the individual fibers of about 1.5 dtex.

Teijin Aramid's recommended yarn for weaving into bullet proof vest is their Twaron™ Microfilament yarn. Their 2040 Microfilament fiber, for instance, consists of 500 fibers wound together for a yarn having a dernier of 550 dtex, implying a fiber dernier of 1.1 dtex. They also supply an Ultra Micro version of Twaron™ that is a yarn having 500 filaments and a fiber dernier of 550 dtex, implying a filament dernier of 0.55 dtex.

The puncture resistance synergy of the microflex fabric layers 220 and the metal mesh layers 225 may be more pronounced when the fiber size of the para-aramid fibers is smallest. This may be indicative of some interaction occurring between the two layers during a puncture attack. This interaction may, for instance, be the para-aramid fibers being forced through or past the metal fibers of the mesh. The kinetic energy expended in stretching the para-aramid fibers through the mesh may be the explanation for the synergistic behavior of the two layers that produces the surprisingly better puncture resistance of when the two are combined as a composite material.

In a preferred embodiment of the present invention the para-aramid fibers may, therefore, be poly-p-phenylene terephthalamide fibers having a fiber dernier of 2 dtex or less that may be bundled, for weaving, into a yarn having 500 or more fibers, with the yarn having a strength at break of 200 N or more, a tenacity at break of 2.3 mN/tex or more and an elongation at break of between 3.4% and 3.8%. In a more preferred embodiment of the present invention, the fiber dernier may be 1.1 dtex or less, and a most preferred embodiment may have a fiber dernier of 0.55 dtex or less.

The ribbon used for braiding may also, for instance, consist of only the microflex fabric layer 220 and the metal mesh layer 225. An outer protective layer 215 may then, if necessary, applied to the braided pipe by a method such as, but not limited to, braiding a protective layer, dip or spray coating the braided pipe with a polymer, or some combination thereof.

In a further embodiment separated ribbons of the microflex fabric 220 and the metal mesh 225 may be braided in alternating layers. An outer protective layer 215 may then, if necessary, applied to the braided pipe by a method such as, but not limited to, braiding a protective layer, dip or spray coating the braided pipe with a polymer, or some combination thereof.

As discussed above, applicant noted an unexpected 30-40% increase in the puncture resistance when microflex fabric layers 120 are combined with metal mesh layers 125. One conjecture is that this unexpected increase may be due to such a combination resulting in, even during low velocity puncture, more of the para-aramid fibers being stretched or broken along a longitudinal axis of the fiber, rather than being broken in shear.

Para-aramid fibers typically have a tensile strength of about 36% more than an equivalent dimensioned steel fiber. As para-aramids are typically only about 18% as dense as steel, this gives them a tensile strength advantage of about a factor of 5, which is why they are often cited as being “five times as strong as steel”. However, para-amid fiber typically have a shear strength that is only about 24% of that of steel. This means that they are much easier to cut or to stab through with either a sharp instrument or a needle. A conjecture for the unexpected 30-40% increase in the puncture resistance when microflex fabric layers 220 are combined with metal mesh layers 225 is that the para-amid fibers are being bent and then stretched through the metal mesh. This would allow a fraction of their superior tensile strength to come into effect even in resisting a low velocity puncture, cut or needle attack.

A similar synergy of the properties of metal and para-aramid fibers may, therefore, also be possible by weaving the fibers into a single layer of fabric.

FIG. 10 shows an isometric view of an inter-woven para-aramid/metal fiber fabric of a further preferred embodiment of the present invention.

In the inter-woven para-aramid/metal fiber fabric 265 shown in FIG. 10, the fabric has alternating warp para-aramid yarn fibers 272 and warp metal fibers 277 as well as alternating weft para-aramid yarn fibers 270 and weft metal fibers 275. One of ordinary skill in the art will, however, appreciate that alternate types of weaving could also be used to create such a composite such as, but not limited to, having all para-aramid yarn weft fibers and all metal warp fibers, or vice versa. In addition to the plain weave pattern illustrated in FIG. 7, other well-known weave patterns such as, but not limited to, a basket weave, a twill weave or a statin weave, or some combination thereof, may be used as some may provide possible advantageous results regarding protection-to-material ratios, or cost advantages.

In a preferred embodiment, the inter-woven para-aramid/metal fiber fabric 265 may be made of para-aramid yarn made of a plurality of individual poly-p-phenylene terephthalamide fibers having a denier of 2 dtex or less, while the metal fibers may be stainless steel fibers having a diameter of 0.2 mm or less.

In a further preferred embodiment of the invention, the inter-woven para-aramid/metal fiber fabric 265 may be woven such the mesh aperture is 0.45 mm or less.

Ribbons of an inter-woven para-aramid/metal fiber fabric 265 may be braided around pipes using the methods and techniques described above.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1: A hose assembly, comprising:
an inner, extruded, smooth bore, flexible tube;
a first helical, metallic layer comprising a first ribbon of wire mesh wrapped in a an overlapped helix having a first direction around said flexible tube; and
a second helical, metallic layer comprising a second ribbon of wire mesh wrapped in an overlapped helix having a direction opposite to the first direction, around said first helical metallic layer.

2: The hose assembly of claim 1, wherein said first and second ribbons of wire mesh comprise stainless steel wires having a diameter of less than 0.20 mm and the apertures between the wires are less than 0.45 mm.

3: The hose assembly of claim 2 wherein a width of said ribbon is in a range of 1 to 3 cm.

4: The hose assembly of claim 2 wherein said ribbon further comprises a microflex fabric layer.

5: The hose assembly of claim 4 wherein said microflex fabric layer is a woven fabric, woven from poly-p-phenylene terephthalamide fibers having a fiber dernier of 2 dtex or less that may be bundled, for weaving, into a yarn having 500 or more fibers, with the yarn having a strength at break of 200 N or more, a tenacity at break of 2.3 mN/tex or more and an elongation at break of between 3.4% and 3.8%.

6: The hose assembly of claim 1 wherein said ribbon further comprises an inter-woven para-aramid/metal fiber fabric.

7: The hose assembly of claim 6 wherein said para-aramid yarn is made of a plurality of individual poly-p-phenylene terephthalamide fibers having a denier of 2 dtex or less, while the metal fibers may be stainless steel fibers having a diameter of 0.2 mm or less

8: A hose assembly, comprising:
an inner, extruded smooth bore, flexible tube; and
a ribbon braided, metallic layer comprising two or more ribbons of woven wire mesh braided together.

9: The hose assembly of claim 8, wherein said ribbons of wire mesh comprise stainless steel wires having a diameter of less than 0.20 mm and the apertures between the wires are less than 0.45 mm.

10: The hose assembly of claim 9 wherein a width of said ribbon is in a range of 1 to 3 cm.

11: The hose assembly of claim 10 further comprising an outer, extruded flexible tube sized to fit over said first and second helixes.

12: The hose assembly of claim 8 wherein a bias of said ribbons of wire mesh is oriented substantially parallel to a length of said ribbons.

13: The hose assembly of claim 8 wherein said first flexible tubing comprises an inner coating of a fluoroelastomer.

14: A ribbon braiding machine, comprising:
a cylindrical mandrel moveable along a mandrel axis of motion, and powered to move linearly along said axis of motion;
a first ribbon carrying armature and a second ribbon carrying armature, each comprising:
a rotational member having a member axis of rotation substantially parallel to said mandrel axis of motion;
an armature arm, fixedly connected to said rotational member at an inner end of said armature arm and oriented orthogonal to said member axis of rotation;
a carrier shaft, oriented substantially parallel to said mandrel axis of motion, and slidably connected to said armature arm in a vicinity of a distal end of said armature arm;
a ribbon carrying bobbin attached to an upper end of said first carrier armature arm, said carrier shaft being powered to move said carrier shaft linearly up and down in a vertical direction such that said ribbon carrying bobbin is moved linearly up and down in said vertical direction; and
wherein said ribbon carriers are rotated in opposite directions such that a combination of said rotational motion and said linear movement in a vertical direction results in said ribbons being intertwined in a spiral fashion to form a tubular fabric.

15: The ribbon braiding machine of claim 14 wherein said ribbon carrying bobbins are sized and shape to carry ribbons having a width of between 1 cm and 3 cm.

16: The ribbon braiding machine of claim 15 sized and shaped to create a tubular fabric having a diameter of between 1 cm and 10 cm.
